(19) United States
(12) Patent Application Publication
(10) Pub. No.: US 2019/0295509 A1
(43) Pub. Date: Sep. 26, 2019

(54) IMAGE RESOLUTION AUTO-IDENTIFYING SYSTEM AND METHOD

(71) Applicant: APLEX TECHNOLOGY INC., New Taipei City (TW)

(72) Inventor: Hsien-Jung CHANG, New Taipei City (TW)

(21) Appl. No.: 15/925,889

(22) Filed: Mar. 20, 2018

(51) Int. Cl. G09G 5/391; G09G 5/00

(52) U.S. Cl. CPC G09G 5/391; G09G 2340/0407; G09G 5/005

(57) ABSTRACT

An image resolution auto-identifying system and a method thereof are disclosed. The image resolution auto-identifying system is installed on a main module, which is electrically connected to a display module. The image resolution auto-identifying system has a detection unit for detecting a voltage state at a second specific pin on the display module and accordingly generating a control signal to a switch unit of the system. According to the received control signal, the switch unit selects to use an expanded display identification data stored on the display module or an expanded display identification data stored on the main module. With these arrangements, the best image resolution most suitable for the display module can be automatically selected without the need of any manual regulation of hardware and firmware by a user.

### FIELD OF THE INVENTION

The present invention relates to a field of image resolution identification, and more particularly to a system and method for automatically selecting an image resolution most suitable for a display module.

### BACKGROUND OF THE INVENTION

A conventional display usually provides only the function of displaying images, and it must be used with a computer main unit or a player to show the images. Recently, due to the growing trend of miniaturization of electronic elements, the integration of a computer main unit into a liquid crystal display (LCD) to provide an all-in-one computer has become very popular. Initially, the computer main unit and the LCD of the all-in-one computer are fixedly integrated with one another, which means the display screen and the computer main unit of the all-in-one computer are not freely changeable or replaceable, which inevitably forms a restriction to the function and the use flexibility of the display of the all-in-one computer.

To solve the problem of the unchangeable function of the display of the all-in-one computer, a modular display structure has been developed to include a display panel detachably connected to a functional computer main unit. The functional computer main unit used in the modular display structure is configured as a removable box that can be added to the display panel. That is, the functional computer main unit and the display panel are combined with each other to provide an integral computer main unit. The functional computer main unit can be in different forms, such as a display controller, an industrial computer main unit or a media player. The display panel can be combined with differently functioned computer main units to provide display devices capable of providing different functions.

While the modular display structure is featured by high use flexibility thereof, the display panels for modular display structures of different sizes and specifications not only have different sizes, but also different image resolutions. Further, in most cases, the display panels for different modular display structures available in the market have their own specific specifications. Therefore, it is possible the functional computer main unit used in one modular display structure is not able to automatically identify different parameters, such as the size and the image resolution, of the display panel connected thereto. At this point, the functional computer main unit must be manually reset or regulated for its different parameters, such as output signal size and image resolution. Therefore, each time the functional computer main unit is connected to a differently configured display panel, a user must take a lot of time to manually reset the parameters of the functional computer main unit. This will obviously result in inconvenience in using the modular display structure and lower the interchangeability of different display panels for use with the same functional computer main unit. As a result, in the conventional modular display structures, the display panels for using with different functional computer main units are usually produced to have only one size and accordingly have largely restricted use flexibility.

It is therefore tried by the inventor to work out a way to solve the above mentioned problems and disadvantages.

### SUMMARY OF THE INVENTION

To overcome the problems and disadvantages in the prior art all-in-one computer and modular display structure, a primary object of the present invention is to provide a system and method for enabling a main module to automatically select the best image resolution most suitable for a display module connected thereto.

Another object of the present invention is to provide an image resolution auto-identifying system and method for automatically selecting the use of an expanded display identification data stored on a display module or an expanded display identification data stored on a main module.

To achieve the above and other objects, the image resolution auto-identifying system provided according to the present invention is installed on a main module and the main module is electrically connected to a display module. The image resolution auto-identifying system provided according to the present invention includes a storage unit having at least one expanded display identification data (EDID) stored thereon; a switch unit connected to the storage unit and a first specific pin on the display module; and a detection unit connected to the switch unit and detecting a voltage state at a second specific pin on the display module to control the switch unit according to the voltage state detected at the second specific pin.

To achieve the above and other objects, the image resolution auto-identifying method provided according to the present invention includes the steps of electrically connecting a display module to a main module that has an image resolution auto-identifying system installed thereon, and initializing the image resolution auto-identifying system; detecting a voltage state at a second specific pin on the display module and generating a control signal accordingly by a detection unit of the image resolution auto-identifying system; and determining by a switch unit of the image resolution auto-identify system according to the control signal transmitted thereto by the detection unit whether to use an expanded display identification data stored on the display module or an expanded display identification data stored on the main module.

With the image resolution auto-identify system and method of the present invention, when the main module is connected to any display module, the detection unit automatically detects the high/low voltage at a specific pin on the display module to determine whether there is an expanded display identification data stored on the display module, and accordingly determines whether to use the expanded display identification data stored on the display module or an expanded display identification data stored on the main module. It is noted the above determination process is automatically completed without the need of any manual hardware and firmware regulation by a user. That is, the present invention provides the function of automatic selection of the best image resolution most suitable for the display module that is currently connected to the main module.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein

FIG. 1A is a perspective view showing a main module and a display module in an assembled state;

FIG. 1B is another perspective view showing the main module and the display module of FIG. 1A in a separated state;

FIG. 2 is a block diagram of an image resolution auto-identifying system according to a preferred embodiment of the present invention, which is installed on the main module of FIGS. 1A and 1B;

FIG. 3 is a block diagram showing a first manner in which the main module having the image resolution auto-identifying system installed thereon is connected to the display module;

FIG. 4 is a block diagram showing a second manner in which the main module having the image resolution auto-identifying system installed thereon is connected to the display module; and

FIG. 5 is a flowchart showing the steps included in an image resolution auto-identifying method according to the present invention.

### DETAILED DESCRIPTION OF THE PREFERRED EMBODIMENTS

The present invention will now be described with a preferred embodiment thereof and by referring to the accompanying drawings.

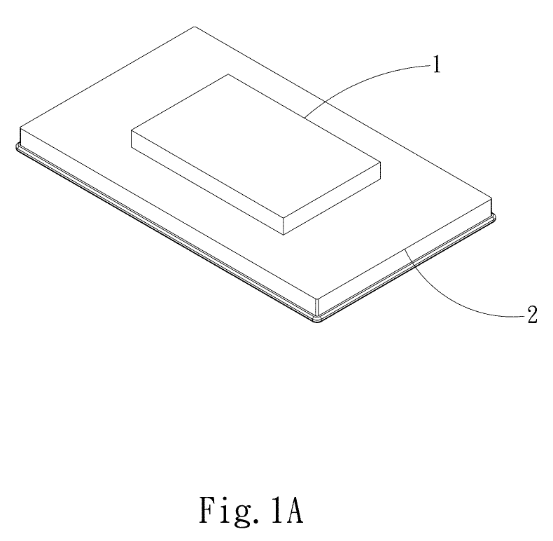

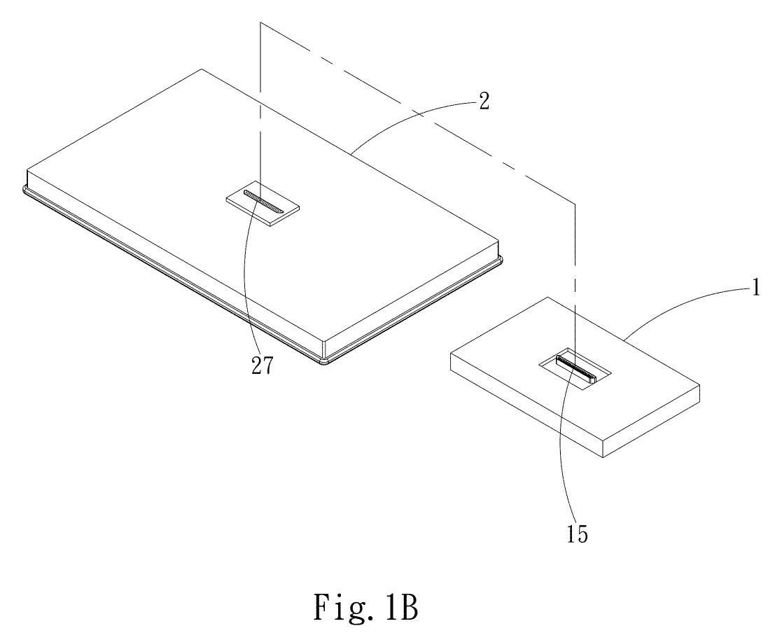

Please refer to FIGS. 1A and 1B, which are perspective views showing a main module 1 and a display module 2 in an assembled and a separated state, respectively. As shown, the main module 1 and the display module 2 are connected to each other via a first connection port 15 provided on the main module 1 and a second connection port 27 provided on the display module 2 to enable connection of electrical, video, audio and touch signals between them. In FIG. 1B, the first connection port 15 is illustrated as a male connector and the second connection port 27 is illustrated as a female connector. However, it is understood, in practical implementation of the present invention, the first and the second connection port 15, 27 are not necessarily limited to a male and a female connector, respectively, but can be freely interchanged. Further, there are not special restrictions to the types and specifications of the first and the second connection port 15, 27. The first and the second connection port 15, 27 can be of any currently commonly used specification, such as connection ports that satisfy the Open Pluggable Specification (OPS), or can be of any possible specification to be developed in the future, so long as the two connection ports 15, 27 can achieve the function of transmitting the above-mentioned signals between them.

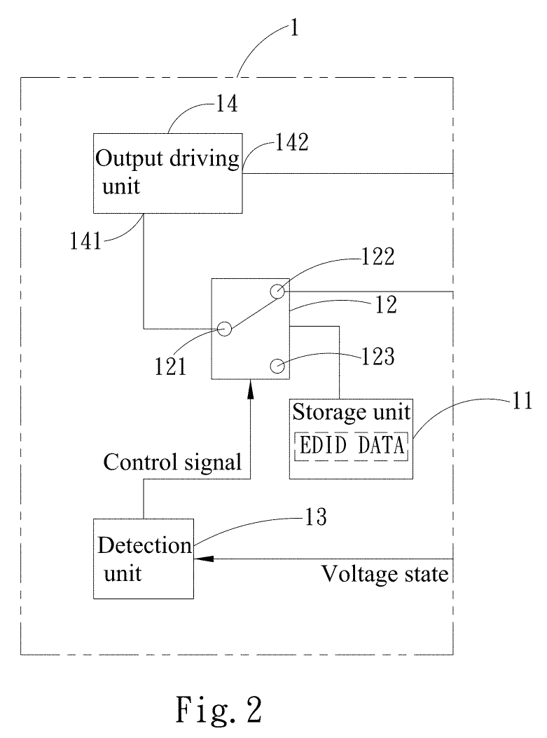

FIG. 2 is a block diagram of an image resolution auto-identifying system according to a preferred embodiment of the present invention, which is installed on the main module 1. Please refer to FIG. 2 along with FIGS. 1A and 1B. The image resolution auto-identifying system includes a storage unit 11, a switch unit 12, a detection unit 13, and an output driving unit 14. These units 11, 12, 13, 14 can be arranged on an independent circuit board or be directly integrated into a motherboard in the main module 1. The switch unit 12 is connected to the storage unit 11, the detection unit 13 and the output driving unit 14.

The storage unit 11 can be, but not limited to, an electrically-erasable programmable read-only memory (EEPROM) or a programmable read-only memory (PROM), and has at least one expanded display identification data (EDID) stored thereon. The expanded display identification data on the storage unit 11 can be edited or replaced.

The switch unit 12 has a common contact 121, a first contact 122 and a second contact 123. The common contact 121 is connected to the output driving unit 14, the first contact 122 is connected to the first connection port 15, and the second contact 123 is connected to the storage unit 11.

The detection unit 13 can be, but not limited to, a micro control unit (MCU). The detection unit 13 detects a voltage state at a specific pin on the display module 2 to generate a control signal accordingly, which is transmitted to the switch unit 12. According to the control signal transmitted thereto, the switch unit 13 selects to close the common contact 121 and the first contact 122 or to close the common contact 121 and the second contact 123.

The output driving unit 14 has an input 141 connected to the common contact 121 and an output 142 connected to the display module 2.

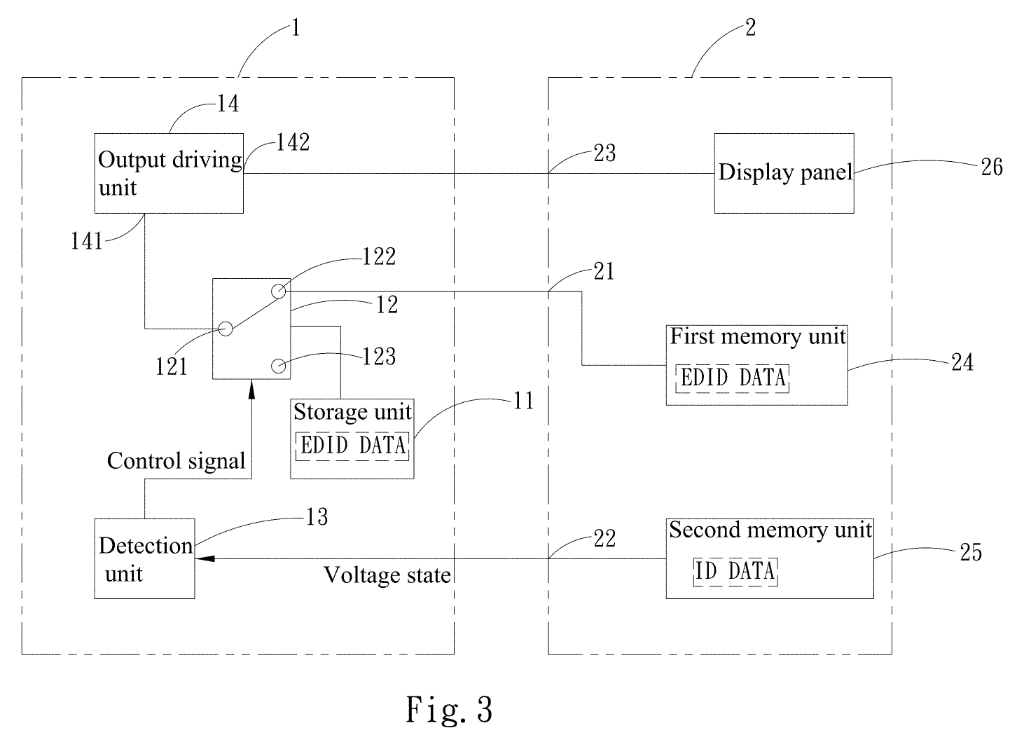

FIG. 3 is a block diagram showing a first manner in which the main module 1 having the image resolution auto-identifying system installed thereon is connected to the display module 2. Please refer to FIG. 3 along with FIGS. 1A, 1B and 2. In FIG. 3, the illustrated display module 2 includes a first specific pin 21, a second specific pin 22, a signal input port 23, a first memory unit 24, a second memory unit 25 and a display panel 26. The first specific pin 21 is connected to the first memory unit 24, the second specific pin 22 is connected to the second memory unit 25, and the signal input port 23 is connected to the display panel 26. When the main module 1 and the display module 2 are connected to each other to form an integral body, the signal input port 23 is connected to the output 142 of the output driving unit 14, the first specific pin 21 is connected to the first contact 122, and the second specific pin 22 is connected to the detection unit 13. The detection unit 13 detects a voltage state at the second specific pin 22, i.e. detects the high or low of the voltage of the second memory unit 25. Then, according to the detected voltage state, the detection unit 13 generates a control signal to the switch unit 12, and the switch unit 12 selects, according to the received control signal, which contacts are to be closed.

In FIG. 3, the detection unit 13 detects the voltage state at the second specific pin 22, and the display module 2 internally includes the second memory unit 25 as well as the first memory unit 24, on the latter an expanded display identification data (EDID) corresponding to the display panel 26 is stored. When the voltage state detected at the second specific pin 22 is high, the detection unit 13 outputs a control signal to the switch unit 12 to close the common contact 121 and the first contact 122, so as to use the expanded display identification data (EDID) stored on the first memory unit 24 in the display module 2.

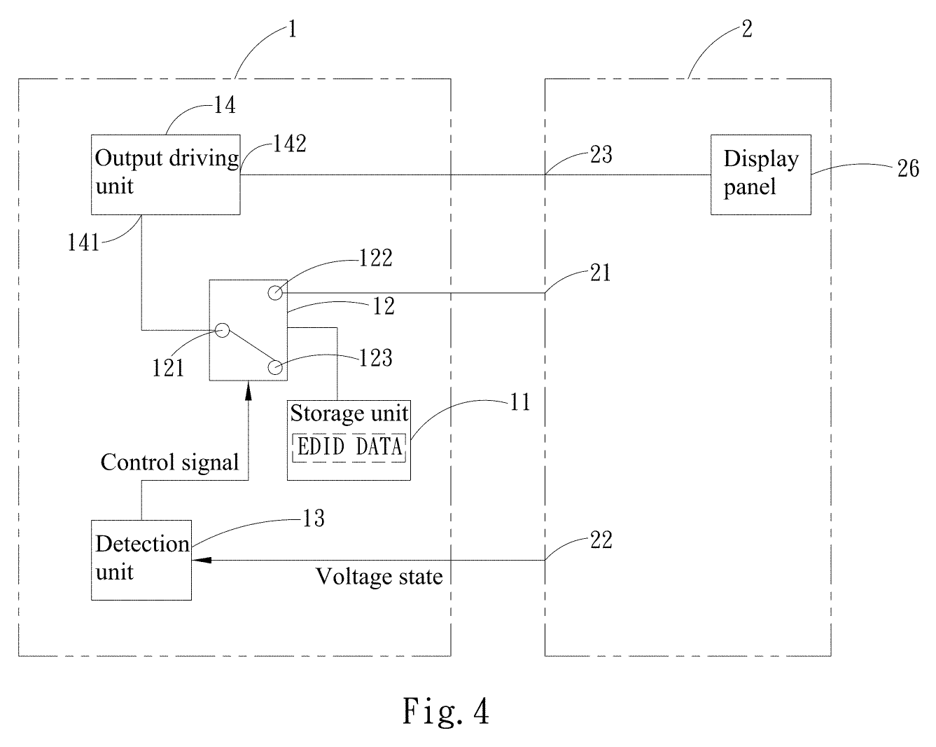

FIG. 4 is a block diagram showing a second manner in which the main module 1 having the image resolution auto-identifying system installed thereon is connected to the display module 2. Please refer to FIG. 4 along with FIGS. 1A, 1B, 2 and 3. In FIG. 4, the illustrated display module 2 includes only a first specific pin 21, a second specific pin 22, a signal input port 23, and a display panel 26. In this case, the first and the second specific pin 21, 22 are NO CONNECT pins. When the main module 1 and the display module 2 are connected to each other to form an integral body, the signal input port 23 is connected to the output driving unit 14, and the detection unit 13 detects the voltage state at the second specific pin 22 is low. Therefore, the detection unit 13 outputs a control signal to the switch unit 12 to close the common contact 121 and the second contact 123, so as to use the expanded display identification data (EDID) stored on the storage unit 11.

Please refer to FIGS. 3 and 4 at the same time. Through detection of the voltage state at a second specific pin 22 on the display module 2, the image resolution auto-identifying system of the present invention can find out whether the display module 2 connected to the main module 1 internally includes the first memory unit 24, which has the expanded display identification data corresponding to the display panel 26 stored thereon, and the second memory unit 25, which has a specification data (ID data) corresponding to the display panel 26 stored thereon, and accordingly generates the control signal to the switch unit 12 to select the most suitable expanded display identification data (EDID) for use. From the above description, one can clearly understand that the expanded display identification data stored on the display module 2 is selected in priority to the expanded display identification data stored on the main module 1. The above selection process does not need any additional operation, and the image resolution auto-identifying system of the present invention can automatically select the best image resolution most suitable for the display module 2.

In the case the display module 2 does not internally include the first memory unit 24 and the second memory unit 25, one of the expanded display identification data stored on the storage unit 11 of the main module 1 that is most suitable for the display module 2 will be selected for use, and the selection of the most suitable EDID is determined according to the high/low value of the voltage state of the display module 2 detected by the detection unit 13 of the main module 1.

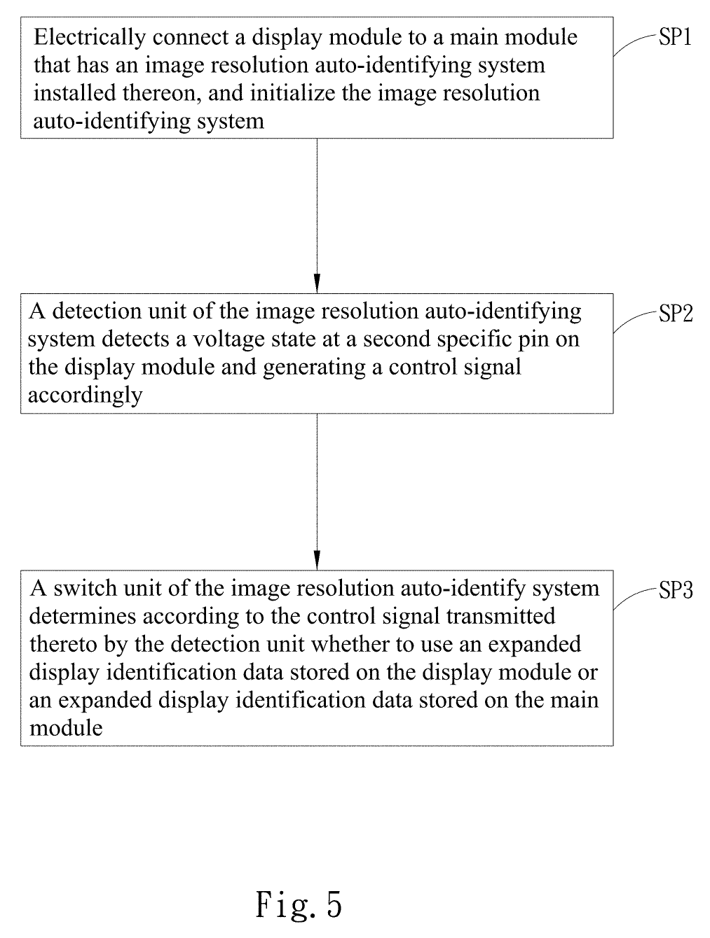

FIG. 5 is a flowchart showing the steps included in an image resolution auto-identifying method according to the present invention. Please refer to FIG. 5 along with FIGS. 1A, 1B, 3 and 4.

In a first step SP1, a main module having an image resolution identify system installed thereon is electrically connected to a display module, and the image resolution auto-identifying system is initialized. More specifically, a main module 1 as describe above is connected to a display module 2 via a first connection port 15 provided on the main module 1 and a second connection port 27 provided on the display module 2, so as to form an integral body. And, when the main module 1 is started, the image resolution auto-identifying system is initialized to correspond to the display module 2 that is currently connected to the main module 1.

In a second step SP2, a detection unit of the image resolution auto-identifying system detects a voltage state at a second specific pin on the display module and generates a control signal accordingly. More specifically, a detection unit 13 of the image resolution auto-identifying system can detect a voltage state, i.e. a high/low voltage value, at a second specific pin 22 on the display module 2 and accordingly generates a control signal to a switch unit 12 of the image resolution auto-identifying system.

In a third step SP3, the switch unit of the image resolution auto-identifying system selects according to the received control signal to use an expanded display identification data stored on the display module or an expanded display identification data stored on the main module. More specifically, according to the control signal sent thereto, the switch unit 12 of the image resolution auto-identifying system either closes a common contact 121 and a first contact 122 thereof or closes the common contact 121 and a second contact 123 thereof, so as to select the use of the expanded display identification data stored on the display module 2 or the expanded display identification data stored on the main module 1.

With the image resolution auto-identify system and method of the present invention, the main module 1 can automatically detect the high/low voltage at the specific pin on the display module 2 that is currently connected thereto to determine whether there is an expanded display identification data stored on the display module 2, and accordingly determines whether to use the expanded display identification data stored on the display module 2 or the expanded display identification data stored on the main module 1. It is noted the above selection or determination process is completely automatically performed without the need of any manual hardware and firmware regulation by a user. That is, the present invention provides the function of automatic selection of the best image resolution and other particular parameters that are most suitable for the display module 2 that is currently connected to the main module 1.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An image resolution auto-identifying system being installed on a main module that is electrically connected to a display module, comprising:
a storage unit having at least one expanded display identification data stored thereon;
a switch unit connected to the storage unit and a first specific pin on the display module; and
a detection unit connected to the switch unit and detecting a voltage state at a second specific pin on the display module to control the switch unit according to the voltage state detected at the second specific pin.

2. The image resolution auto-identifying system as claimed in claim 1, wherein the switch unit has a common contact, a first contact and a second contact; the first contact being connected to the first specific pin, and the second contact being connected to the storage unit.

3. The image resolution auto-identifying system as claimed in claim 2, wherein the main module further includes an output driving unit, which has an input connected to the common contact and an output connected to a signal input port on the display module.

4. The image resolution auto-identifying system as claimed in claim 2, wherein the detection unit outputs a control signal according to the detected voltage state to selectively close the common contact and the first contact or the common contact and the second contact.

5. The image resolution auto-identifying system as claimed in claim 3, wherein the display module includes a display panel, a first memory unit and a second memory unit; the first memory unit having an expanded display identification data corresponding to the display panel stored thereon, and the second memory unit having a specification data corresponding to the display panel stored thereon.

6. The image resolution auto-identifying system as claimed in claim 5, wherein the display panel is connected to the signal input port.

7. The image resolution auto-identifying system as claimed in claim 5, wherein the first memory unit is connected to the first specific pin.

8. The image resolution auto-identifying system as claimed in claim 5, wherein the second memory unit is connected to the second specific pin.

9. An image resolution auto-identifying method, comprising the following steps:
electrically connecting a display module to a main module that has an image resolution auto-identifying system installed thereon, and initializing the image resolution auto-identifying system;
a detection unit of the image resolution auto-identifying system detecting a voltage state at a second specific pin on the display module and generating a control signal accordingly; and
a switch unit of the image resolution auto-identify system determining according to the control signal transmitted thereto by the detection unit whether to use an expanded display identification data stored on the display module or an expanded display identification data stored on the main module.
